(19) United States
(12) Patent Application Publication
(10) Pub. No.: US 2023/0298003 A1
(43) Pub. Date: Sep. 21, 2023

(54) ELECTRONIC WALLET FOR GOVERNING FINANCIAL CONTRACTS BETWEEN MULTIPLE PARTIES

(71) Applicants: Marwan H. Almehmadi, Riyadh (SA); Ahmad H. Almehmadi, Jeddah (SA)

(72) Inventors: Marwan H. Almehmadi, Riyadh (SA); Ahmad H. Almehmadi, Jeddah (SA)

(21) Appl. No.: 18/108,643

(22) Filed: Feb. 12, 2023

Related U.S. Application Data
(60) Provisional application No. 63/321,709, filed on Mar. 20, 2022.

(51) Int. Cl. G06Q 20/36; G06Q 20/40; G06Q 20/10; G06Q 20/38

(52) U.S. Cl. CPC G06Q 20/36; G06Q 20/405; G06Q 20/10; G06Q 20/389

(57) ABSTRACT

A system and method for governing financial contracts between multiple parties are disclosed. The method includes generating a smart electronic contract based on a financial contract between multiple parties. The financial contract includes a set of terms and conditions agreed by the multiple parties. Further, the method includes issuing an electronic wallet based on the generated smart electronic contract. The electronic wallet is developed using blockchain technology. The method further includes issuing a bank account number linked to the generated smart electronic contract upon issuing the electronic wallet and transferring funds to one or more parties among the multiple parties by using the issued bank account number based on the set of terms and conditions agreed by the multiple parties in the financial contract.

### FIELD OF INVENTION

Embodiments of a present disclosure relate to transaction management system and more particularly to an electronic wallet for governing financial contracts between multiple parties.

### BACKGROUND

Usually, there is no governance of financial relations between Business to Business (B2B), Business to Consumer (B2C), Business to Government (B2G), Government to Citizen Services (G2C) and the like, as it is easy to breach contact. Thus, only recourse available to the victim is to approach judiciary. Further, there is no governance of financial relations related parties to ministry of justice. There is also simultaneous consistency with the basic rules. For example, in B2B, there is no integrated ecosystem that guarantees financial rights between main contractor and subcontractor while transferring funds through beneficiary entity (company) to main contractor and transferring amounts according to the contract concluded between the main and subcontractor according to terms of the contract. Furthermore, in an example of B2C, there is no integrated ecosystem of financial rights, solving problems related to other party. In another example of B2C, there is no integrated ecosystem that includes financial rights between property offices with owners in agreeing on percentage and distribution of profits. Further, in an example of G2B or G2C, there is no integrated ecosystem to regulate relevant financial relationships with ministry of Justice, but checks are issued.

For example, the total number of commercial cases received during the year 1442 AH reached 20,297 cases. Further, the number of liquidations of troubled real estate shares for the year 2021 reached one and a half billion. The amounts of the Saudi Investment Fund projects for 2022 projects are 150 billion and more.

Hence, there is a need for an electronic wallet for governing financial contracts between multiple parties in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an electronic wallet for governing financial contracts between multiple parties is disclosed. The electronic wallet includes one or more hardware processors and a memory coupled to the one or more hardware processors. The memory includes a plurality of modules in the form of programmable instructions executable by the one or more hardware processors. The plurality of modules include a contract generation module configured to generate a smart electronic contract based on a financial contract between multiple parties. The financial contract includes a set of terms and conditions agreed by the multiple parties. The multiple parties include contractor and sub-contractor. The financial contract also include name, address, age and contact details of the multiple parties. The plurality of modules also include a wallet issuing module configured to issue an electronic wallet based on the generated smart electronic contract. The electronic wallet is developed using blockchain technology. Further, the plurality of modules include an account issuing module configured to issue a bank account number linked to the generated smart electronic contract upon issuing the electronic wallet. The plurality of modules further include a fund transferring module configured to transfer funds to one or more parties among the multiple parties by using the issued bank account number based on the set of terms and conditions agreed by the multiple parties in the financial contract.

In accordance with another embodiment of the present disclosure, a method for governing financial contracts between multiple parties by using an electronic wallet is disclosed. The method includes generating a smart electronic contract based on a financial contract between multiple parties. The financial contract includes a set of terms and conditions agreed by the multiple parties. The multiple parties include contractor and sub-contractor. The financial contract also include name, address, age and contact details of the multiple parties. Further, the method includes issuing an electronic wallet based on the generated smart electronic contract. The electronic wallet is developed using blockchain technology. Furthermore, the method includes issuing a bank account number linked to the generated smart electronic contract upon issuing the electronic wallet. The method further includes transferring funds to one or more by using the issued bank account number based on the set of terms and conditions agreed by the multiple parties in the financial contract.

In accordance with yet another embodiment of the present disclosure, non-transitory computer-readable storage medium having instructions stored thereon that, when executed by a hardware processor, cause the hardware processor to govern financial contracts between multiple parties by using an electronic wallet. The hardware processor generates a smart electronic contract based on a financial contract between multiple parties. The financial contract includes a set of terms and conditions agreed by the multiple parties. Further, the hardware processor includes issuing an electronic wallet based on the generated smart electronic contract. The electronic wallet is developed using blockchain technology. Furthermore, the hardware processor includes issuing a bank account number linked to the generated smart electronic contract upon issuing the electronic wallet. The hardware processor further includes transferring funds to one or more by using the issued bank account number based on the set of terms and conditions agreed by the multiple parties in the financial contract.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for governing financial contracts between multiple parties is disclosed, in accordance with an embodiment of the present disclosure;

FIG. 2 is a block diagram illustrating an exemplary electronic wallet, such as those shown in FIG. 1, capable of governing financial contracts between multiple parties, in accordance with an embodiment of the present disclosure;

FIG. 3 is a pictorial depiction of an exemplary operation of the electronic wallet capable of governing financial contracts between multiple parties, in accordance with an embodiment of the present disclosure;

FIG. 4 is a process flow diagram for creating contract between concerned parties, in accordance with an embodiment of the present disclosure;

FIG. 5 is a process flow diagram for money between concerned parties, in accordance with an embodiment of the present disclosure; and

FIG. 6 is a process flow diagram illustrating an exemplary method for governing financial contracts between multiple parties by using an electronic wallet, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

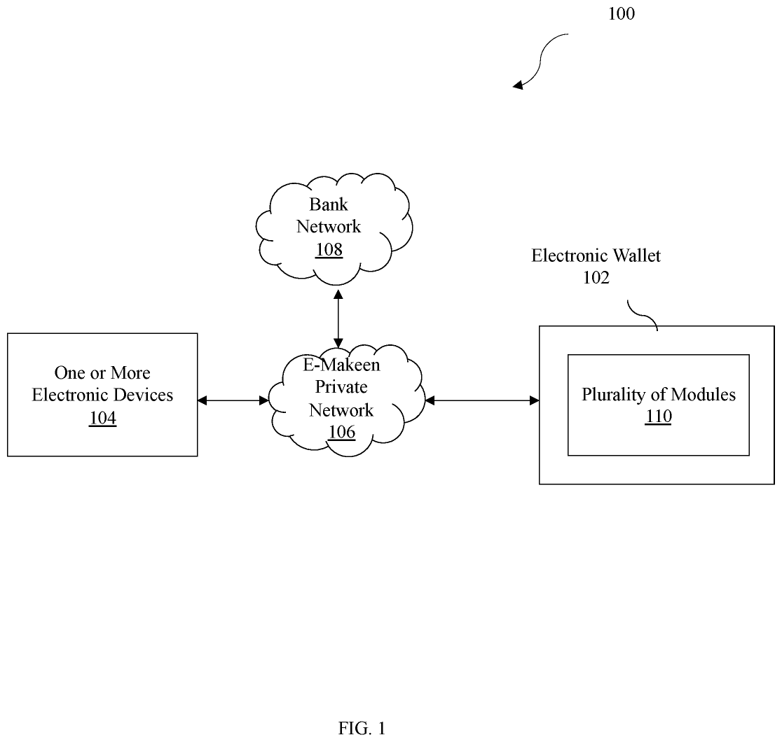

Referring now to the drawings, and more particularly to FIGS. 1A through FIG. 6, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 for governing financial contracts between multiple parties is disclosed, in accordance with an embodiment of the present disclosure. According to FIG. 1, the computing environment 100 includes an electronic wallet 102 communicatively coupled to one or more electronic devices 104 via an E-Makeen private network 106. In an embodiment of the present disclosure, the electronic wallet is a type of pre-paid account in which a user can store his/her money for any future online transaction. The electronic wallet is protected with a password to ensure safety of the user's account. With the help of the electronic wallet, the user can make payments for groceries, online purchases, flight tickets, and the like. In an embodiment of the present disclosure, the E-Makeen private network 106 may be communicatively coupled to a bank network 108. The bank network is a network associated with the bank. In an embodiment of the present disclosure, the electronic wallet 102 is developed using blockchain technology. Further, the one or more electronic devices 104 are associated with the multiple parties. For example, the multiple parties may be contractor, sub-contractor and the like. The multiple parties may use the one or more electronic devices 104 to transfer funds amongst each other. In an exemplary embodiment of the present disclosure, the E-Makeen private network 106 may be internet. In an exemplary embodiment of the present disclosure, the one or more electronic devices 104 may include a laptop computer, desktop computer, tablet computer, smartphone, wearable device, smart watch and the like.

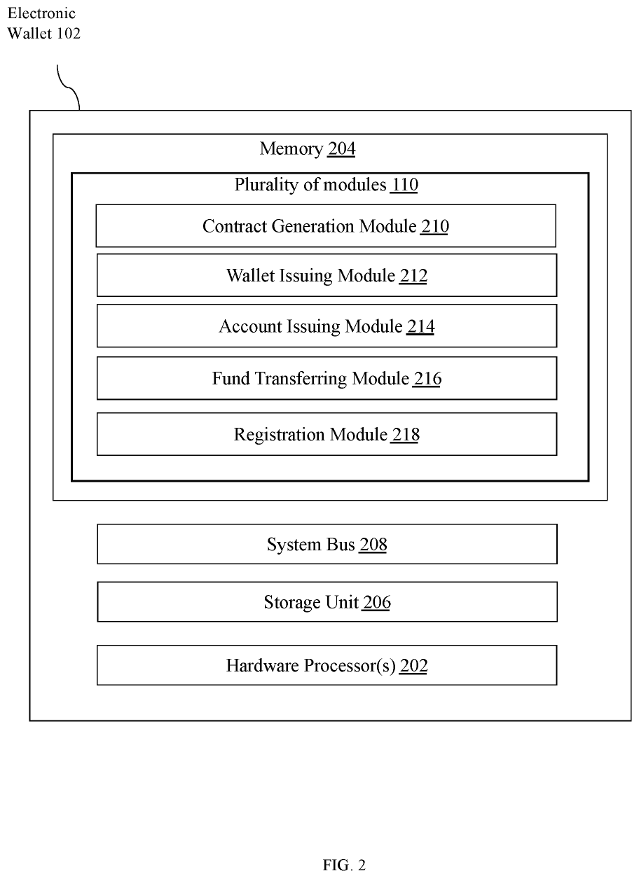

Further, the one or more electronic devices 104 include a web browser, a mobile application or a combination thereof to access the electronic wallet 102 via the E-Makeen private network 106. In an embodiment of the present disclosure, the one or more electronic devices 104 may use a web application through the web browser to access the electronic wallet 102. The mobile application may support android platforms, IOS platforms or both. The electronic wallet 102 includes a plurality of modules 110. Details on the plurality of modules 110 have been elaborated in subsequent paragraphs of the present description with reference to FIG. 2.

In an embodiment of the present disclosure, the electronic wallet 102 generates a smart electronic contract based on a financial contract between multiple parties. The financial contract includes a set of terms and conditions agreed by the multiple parties. For example, the multiple parties may be contractor, sub-contractor and the like. The financial contract also include name, address, age, contact details of the multiple parties and the like. Further, an electronic wallet 102 is issued based on the generated smart electronic contract. The electronic wallet 102 is developed using blockchain technology. The electronic wallet 102 issues a bank account number linked to the generated smart electronic contract upon issuing the electronic wallet 102. Furthermore, the electronic wallet 102 transfers funds to one or more parties among the multiple parties by using the issued bank account number based on the set of terms and conditions agreed by the multiple parties in the financial contract.

FIG. 2 is a block diagram illustrating an exemplary electronic wallet 102, such as those shown in FIG. 1, capable of governing financial contracts between multiple parties, in accordance with an embodiment of the present disclosure. In an embodiment of the present disclosure, the electronic wallet is a type of pre-paid account in which a user can store his/her money for any future online transaction. With the help of the electronic wallet, the user can make payments for groceries, online purchases, flight tickets, and the like. The electronic wallet 102 comprises one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 110 in the form of programmable instructions executable by the one or more hardware processors 202. Further, the plurality of modules 110 includes a contract generation module 210, a wallet issuing module 212, an account issuing module 214, fund transferring module 216 and a registration module 218.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 110 stored in the form of machine-readable instructions on any of the above-mentioned storage media and may be in communication with and executed by the one or more hardware processors 202.

The storage unit 206 may be a cloud storage or a local file directory within a remote server. The storage unit 206 may store the financial contract, the smart electronic contract and the issued bank account number.

The contract generation module 210 is configured to generate the smart electronic contract based on the financial contract between the multiple parties. In an embodiment of the present disclosure, the smart electronic contract is a transaction protocol that is intended to automatically execute, control or document legally-relevant events and actions according to the terms of the financial contract. For example, the multiple parties may be contractor, sub-contractor and the like. In an embodiment of the present disclosure, the financial contract includes a set of terms and conditions agreed by the multiple parties. For example, the set of terms and conditions correspond to rights, obligations, duties, roles, responsibilities, consideration, contact information, signature lines, handling disputes, important dates, deliverables, payment terms, limitations, and the like. The financial contract also include name, address, age, contact details of the multiple parties and the like.

The wallet issuing module 212 is configured to issue the electronic wallet 102 based on the generated smart electronic contract. In an embodiment of the present disclosure, the electronic wallet 102 is developed using the blockchain technology.

The account issuing module 214 is configured to issue the bank account number linked to the generated smart electronic contract upon issuing the electronic wallet 102.

The fund transferring module 216 is configured to transfer funds to one or more parties among the multiple parties by using the issued bank account number based on the set of terms and conditions agreed by the multiple parties in the financial contract.

In an embodiment of the present disclosure, the multiple parties are already registered with the electronic wallet 102. The registration module 218 registers the multiple parties with the electronic wallet 102 based on registration details associated with the multiple parties. In an exemplary embodiment of the present disclosure, the registration details include name, address, age, contact number, verification document, email address of the multiple parties and the like. In an embodiment of the present disclosure, the electronic wallet 102 facilitates governance and guarantees of financial rights between the multiple parties through issuing the wallet based on the smart electronic contract between the multiple parties and issuing the bank account number linked to the electronic contract through which funds are transferred to beneficiaries registered in the electronic wallet 102, developed by using the blockchain technology.

Embodiments of the application further provide a non-transitory computer-readable storage medium, in which a computer program is stored. When executed by the processor, the computer program may govern financial contracts between multiple parties as provided in the embodiments of the application.

The non-transitory computer-readable storage medium may be any combination of one or more computer-readable media. The computer-readable medium may be a computer-readable signal medium or a computer-readable storage medium. The computer-readable storage medium may be, but is not limited to, for example, an electrical, magnetic, optical, electromagnetic, infrared or semiconductor system, device or apparatus or any combination thereof. More specific examples (non-exhaustive list) of the computer-readable storage medium include an electrical connector with one or more wires, a portable computer disk, a hard disk, a RAM, a ROM, an Erasable Programmable ROM (EPROM) or a flash memory, an optical fiber, a portable CD-ROM, an optical storage device, a magnetic storage device, or any proper combination thereof. In the application, the computer-readable storage medium may be any tangible medium including or storing a program that may be used by or in combination with an instruction execution system, device, or apparatus.

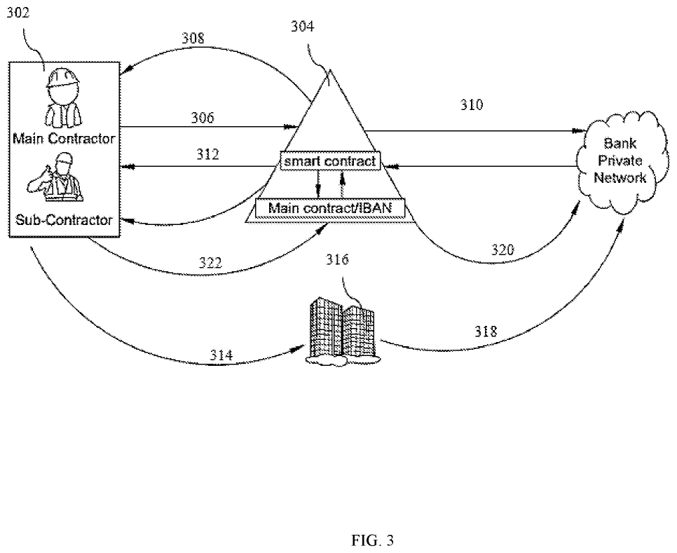

FIG. 3 is a pictorial depiction of an exemplary operation of the electronic wallet 102 capable of governing financial contracts between multiple parties, in accordance with an embodiment of the present disclosure. In FIG. 3, the electronic wallet 102 regulates and governs money transfer for both main contractor and sub-contractor 302 representing trustworthy and valid connection between parties. In an embodiment of the present disclosure, the multiple parties herein are main contractor and sub-contractor 302, as shown in FIG. 3. In an embodiment of the present disclosure, triangle 304 represents the correlation between the smart contract and the main contract. Further, at step 306, the multiple parties initiate smart contract including payment percentage for each milestone of a project. At step 308, the multiple parties receive approved smart contract. Furthermore, at step 310, main contract/electronic wallet International Bank Account Number (IBAN) is initiated to the bank network 108. At step 312, the main contract IBAN/ electronic wallet is sent to the multiple parties, as shown in FIG. 3. Further, at step 314, main contract may submit the bank IBAN for company or government that has project with main contract 316, for transferring the money while finishing the projects depending on milestone achievement between main contract and company or government 316. At step 318, money is transferred to IBAN of main contract/ electronic wallet. At step 320, approved transfer to main contract bank account and sub-contract account is performed, as shown in FIG. 3. Also, at step 322, the permission for both main contract and subcontract is approved to transfer money for each bank account while money transferred in main contract/ electronic wallet.

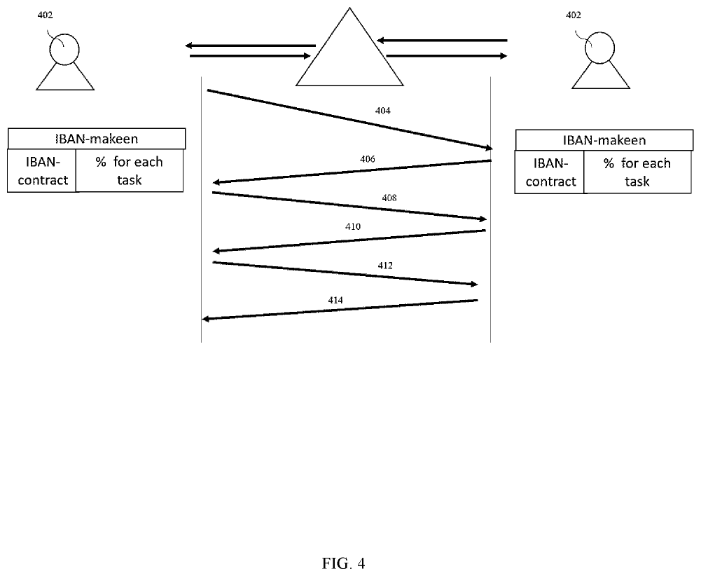

FIG. 4 is a process flow diagram for creating contract between concerned parties, in accordance with an embodiment of the present disclosure. In an embodiment of the present disclosure, 402 represents the concerned parties. At step 404, a smart contract is selected and edited. At step 406, the form is approved or edited by the concerned parties 402. At step 408, smart contract is insulated. At step 410, fragmentation in makeen nodes is performed. At step 412, IBAN from banks is created. At step 414, wallets for the concerned parties 402 are created.

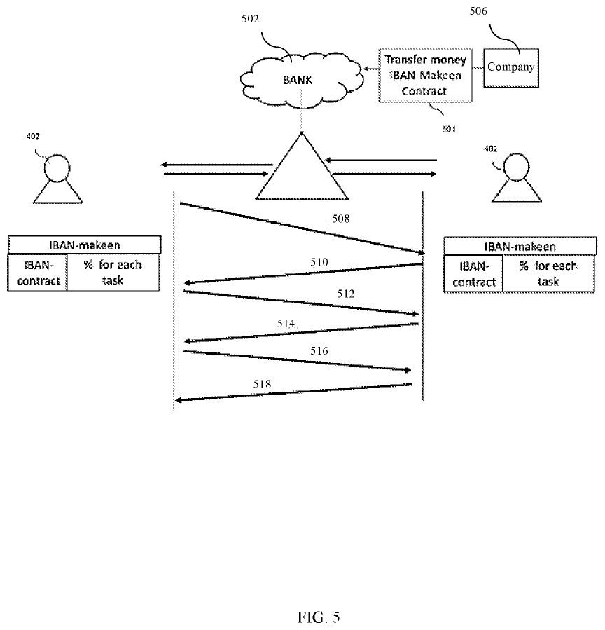

FIG. 5 is a process flow diagram for money between concerned parties, in accordance with an embodiment of the present disclosure. In an embodiment of the present disclosure, the bank 502 receives money in accordance with the IBAN makeen contract at step 504 from the company 506. At step 508, money is stored in makeen account IBAN number. At step 510, smart contract is conducted. At step 512, alert is generated between the concerned parties 402 to approve if plenties. At step 514, money percentage is transferred in wallet of the concerned parties 402. At step 516, IBAN is created from the bank 502. At step 518, wallets are created for the concerned parties 402.

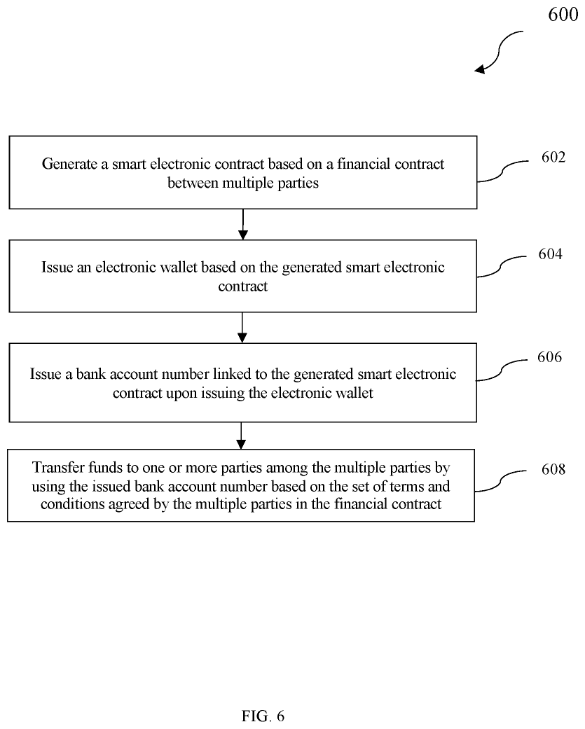

FIG. 6 is a process flow diagram illustrating an exemplary method for governing financial contracts between multiple parties by using an electronic wallet 102, in accordance with an embodiment of the present disclosure. At step 602, smart electronic contract is generated based on financial contract between multiple parties. In an embodiment of the present disclosure, the smart electronic contract is a transaction protocol that is intended to automatically execute, control or document legally-relevant events and actions according to the terms of the financial contract. For example, the multiple parties may be contractor, sub-contractor and the like. In an embodiment of the present disclosure, the financial contract includes a set of terms and conditions agreed by the multiple parties. For example, the set of terms and conditions correspond to rights, obligations, duties, roles, responsibilities, consideration, contact information, signature lines, handling disputes, important dates, deliverables, payment terms, limitations, and the like. The financial contract also include name, address, age, contact details of the multiple parties and the like.

At step 604, an electronic wallet 102 is issued based on the generated smart electronic contract. In an embodiment of the present disclosure, the electronic wallet 102 is developed using blockchain technology.

At step 606, a bank account number linked to the generated smart electronic contract is issued upon issuing the electronic wallet 102.

At step 608, funds are transferred to one or more parties among the multiple parties by using the issued bank account number based on the set of terms and conditions agreed by the multiple parties in the financial contract.

In an embodiment of the present disclosure, the multiple parties are already registered with the electronic wallet 102. The method 600 includes registering the multiple parties with the electronic wallet 102 based on registration details associated with the multiple parties. In an exemplary embodiment of the present disclosure, the registration details include name, address, age, contact number, verification document, email address of the multiple parties and the like. In an embodiment of the present disclosure, the electronic wallet 102 facilitates governance and guarantees of financial rights between the multiple parties through issuing the wallet based on the smart electronic contract between the multiple parties and issuing the bank account number linked to the electronic contract through which funds are transferred to beneficiaries registered in the electronic wallet 102, developed by using the blockchain technology.

The method 600 may be implemented in any suitable hardware, software, firmware, or combination thereof.

Thus, various embodiments of the present invention provide a solution for governing financial contracts between multiple parties. In an embodiment of the present disclosure, the electronic wallet 102 can be used in private sector for governance of the financial relationship between the main contractor and the sub-contractor. Further, the electronic wallet 102 may be used in governance of the financial relationship between law firms and their clients. The electronic wallet 102 can be used in governance of the financial relationship between property management offices and owners. The electronic wallet 102 may also be used in governance of others related to the product. Furthermore, the electronic wallet 102 can be used in government sector for governance of the financial relationship of all parties related to the Ministry of Justice. The electronic wallet 102 may be used in legislation of the distribution of financial dues related to government auctions. Further, the electronic wallet 102 may be used in legislation of the distribution of financial dues related to compensation. The electronic wallet 102 may be used in legislation of the distribution of financial dues following financial settlements. The electronic wallet 102 may also be used in relevant government agencies related to the product.

In an embodiment of the present disclosure, the electronic wallet 102 is an algorithmic wallet with e-mail inside and it provides one or more services, such as wallet service 20, wallet service 70, wallet service through a consultant, provided service from special financial terms, consultant service, and the like. The electronic wallet platform enables the management of the financial relations of all relevant parties, which are stipulated in the electronic contract, and transfer them according to the terms of the contract to their own accounts (extracts, compensation, contribution, and the like) according to the electronic contracts concluded with the concerned parties between B2B, B2C, G2B and G2C. Further, the electronic wallet 102 provide multiple services as mentioned in Table 1.

| Sr. No. | Services |
|---|---|
| 1. | Register on the platform |
| 2. | Opening fee |
| 3. | Transaction fee |
| 4 | Conflict resolution |
| 5. | machine consultant |
| 6. | Building a portfolio through an expert |

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. An electronic wallet for governing financial contracts between multiple parties, the computing system comprising:
a) at least one hardware processor; and
b) a memory coupled to the at least one hardware processor, wherein the memory comprises a plurality of modules in the form of programmable instructions executable by the at least one hardware processor, and wherein the plurality of modules comprises:
c) a contract generation module configured to generate a smart electronic contract based on a financial contract between multiple parties, wherein the financial contract comprises a set of terms and conditions agreed by the multiple parties;
d) a wallet issuing module configured to issue an electronic wallet based on the generated smart electronic contract;
e) an account issuing module configured to issue a bank account number linked to the generated smart electronic contract upon issuing the electronic wallet; and
f) a fund transferring module configured to transfer funds to at least one party among the multiple parties by using the issued bank account number based on the set of terms and conditions agreed by the multiple parties in the financial contract.

2. The electronic wallet of claim 1, wherein the multiple parties comprise contractor and sub-contractor.

3. The electronic wallet of claim 1, wherein the financial contract comprises name, address, age, and contact details of the multiple parties.

4. The electronic wallet of claim 1, wherein the electronic wallet is developed using a blockchain technology.

5. The electronic wallet of claim 1, wherein the multiple parties are already registered with the electronic wallet.

6. The electronic wallet of claim 1, further comprising a registration module configured to register the multiple parties with the electronic wallet based on registration details.

7. The electronic wallet of claim 6, wherein the registration details comprise name, address, age, contact number, verification document, and email address of the multiple parties.

8. The electronic wallet of claim 1, wherein the electronic wallet facilitates governance and guarantees of financial rights between the multiple parties through issuing the wallet based on the smart electronic contract between the multiple parties and issuing the bank account number linked to the smart electronic contract through which funds
are transferred to beneficiaries registered in the electronic wallet.
